(19) United States
(12) Patent Application Publication
(10) Pub. No.: US 2025/0332740 A1
(43) Pub. Date: Oct. 30, 2025

(54) METHOD FOR HANDLING AN OBJECT BY MEANS OF A GRIPPING APPARATUS, AND HANDLING APPARATUS FOR CARRYING OUT THE METHOD

(71) Applicant: J.Schmalz GmbH, Glatten (DE)

(72) Inventors: Ralf Stockburger, Glatten (DE); Matthias Schmider, Dornstetten (DE)

(73) Assignee: J.Schmalz GmbH, Glatten (DE)

(21) Appl. No.: 19/192,580

(22) Filed: Apr. 29, 2025

(30) Foreign Application Priority Data
Apr. 30, 2024 (EP) 24 173 421.9

(51) Int. Cl. B25J 15/06; B25J 9/16; B25J 13/08

(52) U.S. Cl. CPC B25J 15/0616; B25J 9/1612; B25J 13/082

(57) ABSTRACT

The invention relates to a method for handling an object (88) by means of a gripping apparatus (10), comprising a gripper base body (12) and at least one gripping unit (14), held on the gripper base body, comprising a lifting piston (16) which is adjustable relative to the gripper base body in an extension direction (22) and in a retraction direction (24) opposite to the extension direction, wherein the lifting piston can be extended in the extension direction by applying compressed air, the method comprising applying an extension pressure to the lifting piston so that the lifting piston is extended in the extension direction, placing the gripper on the object to be gripped, and gripping the object with the gripper, wherein the lifting piston is subjected to a preset pressure upon placement of the gripper and is subjected to a main pressure after placement, in particular after gripping, wherein the preset pressure is lower than the main pressure. The invention also relates to a handling apparatus for carrying out such a method.

The invention relates to a method for handling an object by means of a gripping apparatus which has at least one gripping unit held on a gripper base body. The gripping unit comprises a lifting piston and a gripper coupled in motion to the lifting piston, wherein the lifting piston is adjustable along a lifting axis between an axially retracted configuration and an axially extended configuration. The invention also relates to a handling apparatus comprising such a gripping apparatus.

Such gripping apparatuses are known from the prior art. To grip an object, the at least one lifting piston is transferred from the retracted configuration to the extended configuration, and then the gripper, coupled in motion to the lifting piston, is placed on the object to be gripped, and the object is gripped. The lifting piston is typically extended by applying compressed air to the lifting piston.

The invention is concerned with the object of making gripping with such a gripping apparatus robust and flexible. In addition, it is desirable to be able to reliably grip objects with irregular surfaces and/or shapes.

This object is achieved according to the invention by a method having the features of claim 1. This is a method for handling an object by means of a gripping apparatus comprising a gripper base body and at least one gripping unit held on the gripper base body, preferably a plurality of gripping units. The method is accordingly also a method for operating such a gripping apparatus.

The gripping unit (in the case of a plurality of gripping units, each gripping unit) comprises a lifting piston and a gripper, in particular a suction gripper, which is coupled in motion to the lifting piston for gripping the object. The lifting piston is adjustable along a lifting axis between an axially retracted configuration and an axially extended configuration relative to the gripper base body. The lifting piston is adjustable along the lifting axis in an extension direction and in a retraction direction opposite to the extension direction. The retracted configuration and the extended configuration of the lifting piston form, in particular, end positions of a displacement path of the lifting piston along the lifting axis. The lifting piston can be loaded, e.g., spring-loaded, in particular into the retracted configuration.

The lifting piston can be extended in the extension direction by applying compressed air, in particular transferred from the retracted configuration to the extended configuration.

According to the method, the lifting piston of the gripping unit (in the case of a plurality of gripping units: the lifting piston of at least one gripping unit) is first pressurized with compressed air at an extension pressure so that the lifting piston is extended in the extension direction starting from the retracted configuration. In particular, the gripper can be activated by extending the lifting piston.

The gripper coupled in motion with the extended piston is then placed on the object to be gripped—for example, by means of a manipulator, in particular a robot.

The object is then gripped with the gripper. If the gripper is designed as a suction gripper, the gripping can, for example, comprise suctioning the object. Gripping can occur instantly upon placement, or can comprise a time interval after placement.

According to the invention, the lifting piston is pressurized with compressed air at a preset pressure during placement and, after placement, in particular after gripping, is pressurized with compressed air at a main pressure, wherein the preset pressure is lower than the main pressure. In this respect, after placement, in particular after gripping, the pressure acting upon the lifting piston is increased. By applying the preset pressure or the main pressure to the lifting piston, the lifting piston is acted upon in the extension direction, in particular against an optional spring load in the retraction direction.

In the proposed method, the at least one lifting piston is subjected to a reduced pressure upon placement so that the lifting piston can at least slightly yield in the retraction direction upon placement (“compression”). In other words, the proposed method promotes a gentle placement of the gripper on the object, which reduces the risk of damage to the gripper and/or the object. In addition, the compression of the piston can compensate for possible unevennesses on the component surface (higher tolerance), which promotes reliable gripping, in particular reliable sealing given a design of the gripper as a suction gripper. After placement, the lifting piston is then transferred into a stable configuration (in particular, a lifting piston in extended configuration) by applying the higher main pressure, so that the object is held in a defined position on the gripping apparatus. This facilitates reliable and positionally accurate handling of the object.

An exemplary implementation option of the gripping unit provides that the lifting piston be displaceable in a gripping unit housing, and a pressure chamber be formed in the gripping unit housing and interact fluidically with the lifting piston in such a way that, by applying compressed air to the pressure chamber, a force acting in the extension direction is exerted on the lifting piston. In particular, the gripping apparatus then comprises a compressed air connection for connection to a compressed air supply device in particular, and a compressed air distribution system for conducting the compressed air to the at least one gripping unit. In order to adjust a pressure value of the compressed air at the pressure chamber, a pressure adjustment device for adjusting a pressure of the compressed air can be provided, in particular as part of the compressed air supply device.

Additionally, in particular when the gripper is designed as a suction gripper, the gripping apparatus can have a negative pressure connection for connection to a negative pressure supply and a negative pressure distribution system for conducting a negative pressure to the at least one gripping unit.

It is also conceivable in principle that the pressure chamber be a negative pressure chamber. In this respect, the pressure chamber can be designed in such a way that the lifting piston can be displaced in the extension direction by applying a negative pressure to the negative pressure chamber.

It is conceivable that the piston be subjected to the preset pressure only at the moment of placement (and, for example, to the extension pressure beforehand). Preferably, however, the piston is pressurized with the preset pressure already before placement, and then during placement. This facilitates the gripping of objects with irregularly curved surfaces where an exact point of placement cannot be defined or is difficult to define.

The main pressure is preferably selected in such a way that the lifting piston is transferred into the extended configuration by the application of the main pressure and/or is held in the extended configuration. In other words, after placement, in particular after gripping, the lifting piston is preferably pressurized with compressed air in such a way that the lifting piston is transferred into the extended configuration and/or is held in the extended configuration by the application of the main pressure. For example, it is conceivable that the gripping apparatus be first lifted after gripping, in particular so that the lifting piston is transferred into the extended configuration as a result of the weight force of the object then acting upon it, and then the main pressure be applied to the lifting piston, in particular so that the lifting piston is fixed in the extended configuration. It is also conceivable that the lifting piston be in an intermediate position between the retracted configuration and the extended configuration when the preset pressure is applied, and then, by applying the main pressure to the lifting piston, be first transferred from the intermediate position into the extended configuration and then be held there, against the optional spring loading.

It has proven particularly advantageous if the preset pressure is at most half as high as the main pressure. In this respect, the main pressure is preferably at least twice as high as the preset pressure. In this way, compression of the piston is made easier.

It is conceivable that the preset pressure correspond to the ambient pressure. For example, applying the preset pressure to the lifting piston can involve switching off or interrupting a compressed air supply. Preferably, the preset pressure is, however, a positive pressure.

It has proven particularly advantageous if the preset pressure lies between 0 and 2 bar. Furthermore, it proves advantageous if the main pressure is between 4 and 6 bar, in particular between 4.5 and 5.5 bar. It is particularly advantageous if the preset pressure lies between 0 and 2 bar, and the main pressure lies between 4 and 6 bar, in particular between 4.5 and 5.5 bar.

It is conceivable that the preset pressure be selected in such a way that the piston is transferred into the extended configuration when freely extended (i.e., without contact with an object). Such a design facilitates a controlled placement of the gripper, since the gripper is thereby held in a precisely defined position (end position of the displacement path along the lifting axis).

It is also conceivable that the preset pressure be selected in such a way that the lifting piston is transferred to an intermediate position (along the lifting axis) between the retracted configuration and the extended configuration when freely extended (i.e., without contact with an object). Such a design then enables a relative movement of the lifting piston in both directions (retraction and extension directions) upon placement of the gripper.

In the context of an exemplary embodiment, the lifting piston is loaded in the direction of retraction, in particular into the retracted configuration, in particular spring-loaded. The preset pressure can then be selected in such a way that the piston is moved into the extended configuration when freely extended (i.e., without contact with an object) —counter to the spring load—or is transferred into an intermediate position between the retracted configuration and the extended configuration.

The extension pressure is preferably greater than the preset pressure. In particular, the extension pressure is selected in such a way that the lifting piston is transferred from the retracted configuration to the extended configuration. In this way, it can be ensured that the lifting piston is extended and, in particular, that the gripper is thereby activated. In particular, the extension pressure and main pressure can be identical.

In the context of an advantageous embodiment of the method, the lifting piston can initially be subjected to a first pressure (extension pressure) in order to extend from the retracted configuration, this pressure can then be reduced to a second pressure (preset pressure), in particular before being placed on an object to be gripped, at the reduced second pressure (preset pressure), the gripper can be placed on the object, and, after being placed, in particular after gripping, further in particular after lifting the object, the pressure can be increased again to a third pressure (main pressure, in particular equal to the extension pressure).

In alternative embodiments, the extension pressure can, however, also correspond to the preset pressure. In this respect, the same pressure can be applied to the lifting piston for (initial) extension from the retracted configuration, and applied to the piston upon placement.

As mentioned above, applying the reduced preset pressure to the piston allows the piston to compress in the retraction direction. Preferably, the gripper is placed on the object to be gripped in such a way that the lifting piston is (actively) displaced in the retraction direction—counter to the application of the preset pressure. In this way, reliable gripping, especially sealing, can be achieved.

In the context of an advantageous further development, a sensor device for monitoring a gripping state of the gripper can also be provided, in particular as part of the gripping apparatus. It is then possible for the sensor device to monitor a gripping state of the gripper and for the pressure acting upon the lifting piston to be changed as a function of an output signal from the sensor device; in particular, the pressure acting upon the lifting piston is increased from the preset pressure to the main pressure upon detection of the gripping of an object by the gripper.

In the context of a particularly advantageous embodiment, the gripper of the at least one gripping unit is designed as a suction gripper for suctioning an object by means of negative pressure. The suction body delimits in particular a suction chamber open through a suction opening.

In such an embodiment with a suction gripper, a sensor device for monitoring a negative pressure prevailing in the suction chamber can also be provided, in particular as part of the gripping apparatus. It is then possible that, during the placement, the negative pressure prevailing in the suction chamber be monitored by means of the sensor device, and, upon detection of a pressure in the suction chamber exceeding or falling below a predetermined or predeterminable pressure threshold value, the pressure acting upon the lifting piston be increased from the preset pressure to the main pressure. The sensor device can, for example, comprise a pressure sensor. The sensor device can interact via a control device with the aforementioned pressure adjustment device for adjusting a pressure of the compressed air. The pressure threshold value can, for example, be stored in a memory device of a control device.

The aforementioned object is also achieved by a handling apparatus having the features of claim 11. This is a handling apparatus for handling an object. The handling apparatus is designed in particular to carry out one of the methods described above.

The handling system comprises a gripping apparatus comprising a gripper base body and at least one gripping unit held on the gripper base body. The gripping unit (in the case of a plurality of gripping units, each gripping unit) comprises a lifting piston and a gripper, in particular a suction gripper, which is coupled in movement to the lifting piston for gripping the object, wherein the lifting piston is adjustable along a lifting axis between an axially retracted configuration and an axially extended configuration in an extension direction and in a retraction direction opposite to the extension direction relative to the gripper base body.

The gripping unit has a gripping unit housing in which the lifting piston can be moved. The gripping unit housing can be formed at least partially by the gripper base body. The gripping unit housing can be provided separately from the gripper base body and fastened to the gripper base body. In the gripping unit housing, a pressure chamber, in particular a compressed air chamber, is formed, which interacts fluidically with the lifting piston in such a way that, by applying compressed air to the pressure chamber, a force acting in the extension direction is exerted on the lifting piston. The pressure chamber can be formed by a portion of a housing interior of the gripping unit housing.

The handling apparatus also comprises a compressed air supply device for supplying the pressure chamber with compressed air. The compressed air supply device can comprise a compressed air supply (e.g., comprising a compressor device), provided separately from the gripping apparatus, for providing compressed air to the gripping apparatus.

In particular, the gripping apparatus comprises a compressed air connection for connection to such a compressed air supply and a compressed air distribution system, in particular integrated into the gripper base body, for conducting the compressed air to the at least one gripping unit. In the context of an advantageous development, the gripping apparatus can have, in particular as part of the compressed air distribution system, a valve device which is designed to control a compressed air supply to the lifting pistons, in particular independently of one another, in particular to block or release a flow connection between the lifting pistons and the compressed air connection as required. The valve device can in particular have a separate compressed air valve for each gripping unit. The valve device can in particular be arranged in the gripper base body.

The handling apparatus also comprises, in particular as part of the compressed air supply device, a pressure adjustment device for adjusting a pressure of the compressed air. The pressure adjustment device is designed in particular to adjust a supply pressure of the compressed air applied to the pressure chamber, in particular to the pressure connection of the gripping apparatus. The pressure adjustment device can, for example, be designed to regulate, in particular to reduce, a pressure provided by an external compressed air supply. Such a pressure adjustment device can be realized, for example, by an adjustable valve. The pressure adjustment device can be part of the gripping apparatus. Then, the pressure adjustment device can be arranged in particular downstream of the compressed air connection. Preferably, however, the pressure adjustment device is provided upstream of the compressed air connection, e.g., as part of the compressed air supply.

The handling apparatus may also comprise a manipulator for displacing the gripping apparatus. In particular, the manipulator may be designed as a robot.

The handling apparatus also comprises a control device for controlling the handling apparatus, in particular the pressure adjustment device and the optional manipulator. The control device can comprise one or more sub-control devices—for example, a control device of the gripping apparatus and a control device of the manipulator.

The control device is configured to carry out one of the methods described above. In particular, the control device is designed to control the pressure adjustment device as a function of a gripping state of the gripper. Preferably, the control device comprises a non-volatile memory device on which control instructions are stored which cause the control device, e.g., when executed on a data processing device of the control device, to carry out one of the methods described above.

In particular, the control device is configured to initially control the pressure setting device in such a way that the at least one lifting piston is subjected to an extension pressure in order to grip an object so that the lifting piston is extended in the extension direction, starting from the retracted configuration, while or afterwards controlling the optional manipulator in such a way that it places the gripping apparatus with the gripper, which is coupled in motion to the extended lifting piston, on the object to be gripped, wherein the control device is configured to control the pressure setting device in such a way that the lifting piston is subjected to a preset pressure when the gripper is placed, and is subjected to a main pressure after placement, in particular after gripping, wherein the preset pressure is lower than the main pressure. The control device is also optionally configured to activate the gripper after placement so that it grips the object. Preferably, however, the gripper is already activated by the extension of the lifting piston from the retracted configuration.

In the context of an advantageous further development, the gripper is designed as a suction gripper, with a suction body which delimits a suction space open through a suction opening. It can then be advantageous if the handling apparatus also comprises a sensor device cooperating with the control device, in particular comprising at least one pressure sensor, for monitoring a negative pressure prevailing in the suction chamber. The sensor device can in particular be provided as part of the gripping apparatus.

Advantageously, the control device can then be configured to control the sensor device in such a way that it monitors the negative pressure prevailing in the suction chamber during the placement of the suction gripper on the object to be gripped.

The control device can in particular be configured to control the pressure setting device, upon detection of a pressure in the suction chamber which falls below or exceeds a predetermined pressure threshold value, in such a way that it increases the pressure acting upon the pressure chamber and therefore on the lifting piston from the preset pressure to the main pressure.

The advantages and optional features described above in connection with the method can also be used in the realization of the handling apparatus, so that reference is made to the above disclosure in this respect in order to avoid repetition.

Further advantageous developments of the gripping apparatus are described below, which can serve both for designing the method and for designing the handling apparatus.

The gripper can in principle be designed in different ways. In an advantageous embodiment, the gripper can assume a passive configuration in which no gripping force is exerted on an object and an active configuration in which a gripping force is exerted on the object. In this respect, the gripper can be activated and deactivated as required. It is particularly advantageous if the gripping unit is designed such that the gripper is in the passive configuration when the retracted configuration of the lifting piston is used and is transferred to the active configuration by extending the lifting piston from the retracted configuration to the extended configuration. In this respect, the gripper can be activated by extending the lifting piston and thus a gripping force be provided, which simplifies the control and design of the gripping apparatus.

As mentioned above, it is particularly preferred if the gripper of at least one gripping unit is designed as a suction gripper for suctioning an object to be gripped. In this respect, at least one gripping unit can be a suction gripping unit. Preferably, the suction gripper can be subjected to negative pressure through the lifting piston. In particular, the gripping unit can be designed in such a way that, in the extended configuration of the lifting piston, the suction gripper is supplied with negative pressure, and, particularly in the retracted configuration, a negative pressure supply is interrupted.

The suction gripper can be designed in different ways. In particular, the suction gripper can have one or more suction points for suctioning the object. For example, it is conceivable that the suction gripper be designed as an elastomer suction unit comprising at least one suction body. The suction body can be plugged or screwed onto the lifting piston. In embodiments with multiple gripping units, it is conceivable that different gripping units have different suction grippers, in particular suction bodies of different sizes, or have a different number of suction bodies. Due to the differences in the suction grippers, the damping behavior (soft/hard) during placement can be influenced, in particular adjusted.

In embodiments with suction grippers, the gripping apparatus, in particular on the gripper base body, preferably comprises a negative pressure connection for connection to an in particular external negative pressure supply device. In particular, the gripping apparatus then also comprises a negative pressure distribution system, preferably integrated into the gripper base body, for distributing negative pressure to the at least one gripping unit. The handling apparatus may comprise the negative pressure supply device. The negative pressure supply device can comprise a negative pressure generating device for generating and providing negative pressure.

The gripping unit can preferably be designed in such a way that, in the extended configuration of the lifting piston, a flow connection is established between the negative pressure connection and the suction gripper, and, in the retracted configuration of the lifting piston, this flow connection is blocked. For example, a shut-off device for shutting off and releasing the flow path between the negative pressure connection and the suction gripper can be provided, which assumes a blocking position in the retracted configuration of the lifting piston and is transferred into a release position by extending the lifting piston into the extended configuration. In this respect, the suction gripper can be activated by extending the lifting piston. Preferably, in the case of a plurality of gripping units, the flow cross-sections are designed so that a system vacuum does not collapse if individual suction grippers are unoccupied or are leaky.

As mentioned above, the gripping apparatus can have a valve device which is designed to control a compressed air supply to the lifting pistons, in particular independently of one another. In this connection, it can further be advantageous if the gripping apparatus has a gripper control device, in particular a control board, which is designed to control the valve device. The gripping apparatus can in this respect have its own, in particular autonomous, control system. The gripper control device can be part of the aforementioned control device of the handling apparatus.

The valve device and/or the gripper control device can be arranged in or on the gripper base body.

The gripping units can be designed in such a way that the lifting pistons are loaded, in particular spring-loaded, into the retracted configuration. In particular, the gripping units can be designed in such a way that they are automatically transferred, e.g., by the spring action described above, into the retracted configuration when the pressure is removed. In this respect, in an initial configuration, the gripping units can be in the retracted configuration.

In designs with a plurality of gripping units, these are preferably arranged on the gripper base body in such a way that the lifting axes of the gripping units run parallel to one another. In this way, a particularly compact arrangement is created which is particularly suitable for gripping flat components such as sheet metal. In addition, such an arrangement promotes a flexible, modular design.

The gripper base body can be formed in one part or in multiple parts. The gripper base body can have a fastening portion for fastening to a support, e.g., a flange plate of a manipulator.

Furthermore, it can be advantageous if a pressure chamber, in particular a negative pressure chamber, is formed between an end, opposite the gripper, of the lifting piston and an inner housing wall of the gripping unit housing, so that, in the extended (active) configuration, an air cushion is provided behind the lifting piston, which forms a collision protection when the gripper is placed on an object. In this way, both the object and the suction gripper can be further protected.

The lifting pistons can be mounted so that they cannot rotate around the lifting axis. For example, it is conceivable that the lifting pistons be secured against rotation by means of interacting circular segments. Such an anti-rotation lock is thus non-clamping.

The gripping apparatus can also be provided with least one sensor for distance monitoring or collision warning. The sensors can be connected to the optional control device and can be controlled by it.

In the context of an advantageous development, a plurality of the gripping apparatuses described above can be combined to form a higher-level gripping module. The handling apparatus can therefore comprise a gripping module comprising a plurality of gripping apparatuses. The gripping apparatuses are preferably arranged next to one another and connected to one another. For example, it is conceivable that the gripper base bodies of the gripping apparatuses be interlocked with each other. The gripping apparatuses can be controlled independently of each other. The gripping apparatuses of the gripping module can be electrically connected to each other.

The invention is explained in more detail below with reference to the figures, in which:

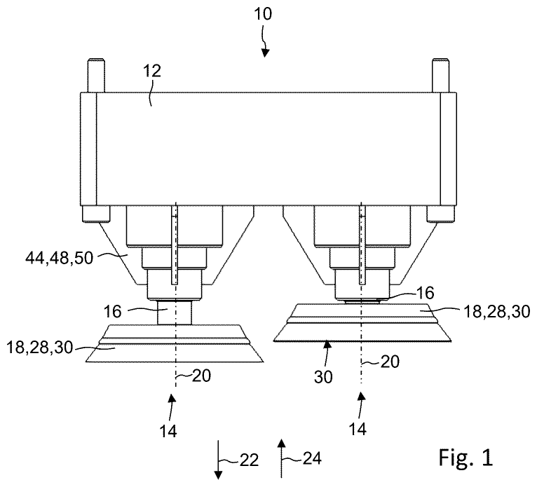

FIG. 1 is a graphic representation of an exemplary embodiment of a gripping apparatus;

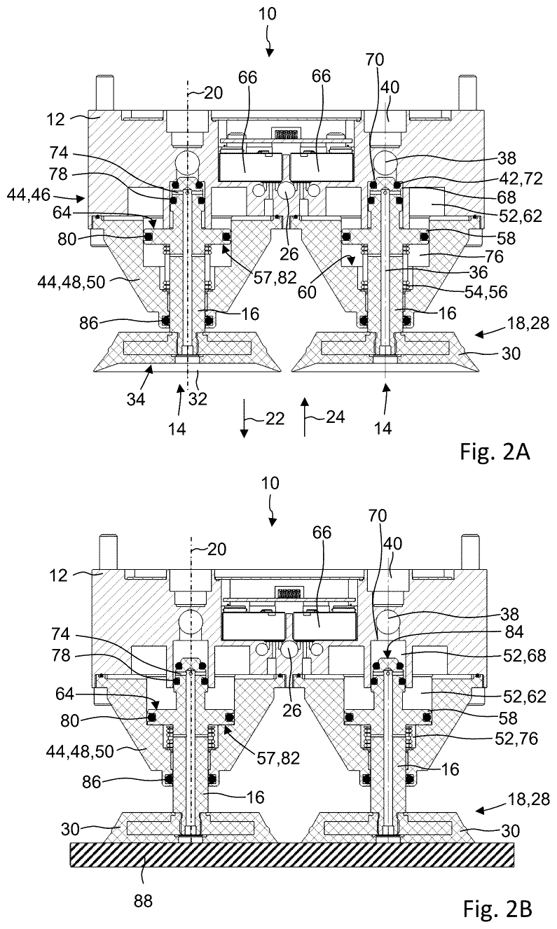

FIG. 2A, B are sectional views of the gripping apparatus according to FIG. 1 for explaining a mode of operation, with lifting pistons in the retracted passive configuration (view A) and in the extended active configuration (view B); and

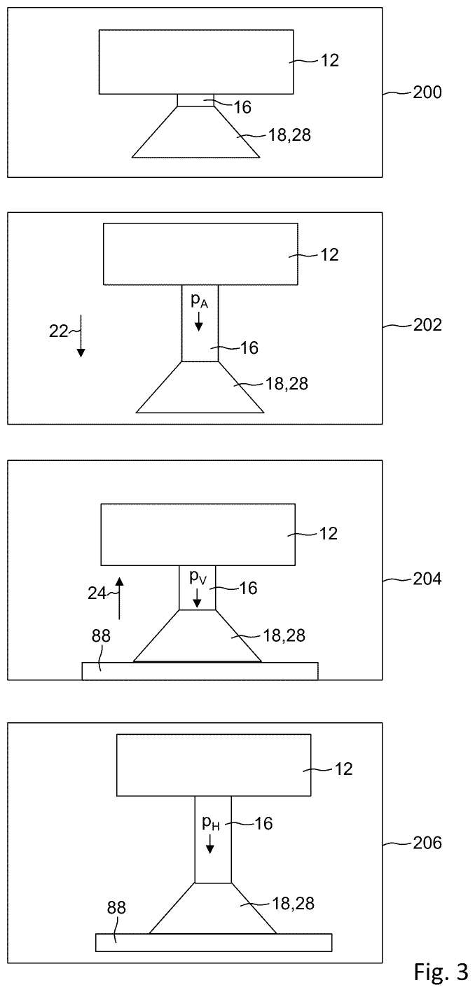

FIG. 3 shows simplified schematic representations for explaining an exemplary method for gripping an object with a gripping apparatus according to FIG. 1.

FIG. 1 shows an exemplary embodiment of a gripping apparatus, which is denoted as a whole by reference sign 10.

The gripping apparatus 10 comprises a gripper base body 12 and at least one—in the example, two—gripping units 14 arranged thereon. In undepicted embodiments, more or fewer gripping units 14 may also be provided.

The gripping apparatus 10 can in particular be part of a higher-level handling apparatus. The handling apparatus can, for example, in a basically known manner, comprise a manipulator, e.g., a robot, for displacing the gripping apparatus 10. The handling apparatus preferably also comprises a control device for controlling the handling apparatus.

Each gripping unit 14 comprises a lifting piston 16 and a gripper 18 which is movably coupled to the lifting piston 16.

The lifting piston 16 of a respective gripping unit 14 can be displaced along a lifting axis 20 between an axially retracted configuration (cf. FIG. 2A) and an axially extended configuration (cf. FIG. 2B). In particular, the lifting piston 16 is adjustable along the lifting axis 20 in an extension direction 22 and in a retraction direction 24 opposite the extension direction 22.

The gripping units 14 are, for example, preferably arranged next to one another on the gripper base body 12 in such a way that the lifting axes 20 of the lifting pistons 16 run parallel to one another.

As explained in detail below, the lifting piston 16 of a respective gripping unit 14 can be transferred from the retracted configuration to the extended configuration by applying compressed air (described in detail below). For this purpose, the gripping apparatus 10 also comprises a compressed air connection (not visible) for connection to an external compressed air supply and a compressed air distribution system 26, in particular integrated into the gripper base body 12, for distributing the compressed air from the compressed air connection to the gripping units 14 (cf. FIGS. 2A and 2B).

The compressed air supply is in particular part of the handling apparatus mentioned above and can, for example, comprise compressors. As mentioned above, a pressure adjustment device, e.g., in the form of a control valve, is preferably also provided, in order to adjust a pressure of the compressed air applied to the compressed air connection.

In the shown example, the grippers 18 are designed as suction grippers 28. In this respect, the gripping apparatus 10 is a suction gripping apparatus. In undepicted embodiments, it is, however, also conceivable that the grippers 18 comprise other gripping mechanisms.

In the example according to FIG. 1, the suction grippers 28 are each formed by a suction body 30, in particular an elastomer suction body, which delimits a suction chamber 34 open through a suction opening 32 (cf. FIG. 2A).

In the exemplary configuration according to FIG. 1, the suction grippers 28 (suction bodies 30) are identical to one another. In undepicted embodiments, the type and size of the suction grippers 28 can also vary. For example, it is conceivable that suction bodies 28 of different sizes be provided on different gripping units 14.

As explained in detail below, the suction grippers 28 can be supplied with negative pressure via a negative pressure channel 36 formed in the respective lifting piston 16. The negative pressure channel 36 can be supplied with negative pressure via a negative pressure distribution system 38 having a negative pressure connection 40 of the gripping apparatus 10. For example, a separate negative pressure connection 40 and a separate negative pressure distribution system 38 are provided for each gripping unit 14. However, it is also possible for the gripping units 14 to be supplied with a negative pressure via a common negative pressure connection 40 and a common negative pressure distribution system 38.

A negative pressure supply to the negative pressure channel 36 and therefore a negative pressure supply to the suction gripper 28 is controlled in the example via an optional shut-off device 42 (described in detail below) in such a way that, in the retracted configuration of the lifting piston 16, a flow path between the negative pressure channel 36 and the negative pressure connection 40, and therefore between the suction gripper 28 and the negative pressure connection 40, is blocked (passive configuration), and, in the extended configuration of the lifting piston 16, this flow path is opened (active configuration).

An exemplary configuration of the gripping units 14, in particular a mode of operation of the lifting pistons 16, is explained below with reference to FIGS. 2A and 2B.

As can be seen from FIG. 2A, the lifting pistons 16 are displaceably guided in a respective gripping unit housing 44 along the lifting axis 20. In the example, the gripping unit housing 44 is designed in several parts and comprises a first, upper section 46 which is formed by the gripper base body 12, and a second, lower section 48 which is provided by an attachment 50 connected to the gripper base body 12. In undepicted embodiments, the gripping unit housing 44 can, however, also be formed in one piece and held on the gripper base body 12.

The gripping unit housing 44 delimits a housing interior 52 in which the lifting piston 16 is guided so as to be displaceable along the lifting axis 20.

In the example, the lifting piston 16 is moved into the retracted configuration by an optional spring device 54. The spring device 54 comprises a compression spring 56. The compression spring 56 is supported with a first end on an inner housing wall of the gripping unit housing 44 (in the example, on an inner housing wall of the lower section 48/attachment 50) and with the second end on an end face 57, oriented in an extension direction 22, of a radial projection 58 of the lifting piston 16 (for the sake of clarity, only a part of the spring 56 is shown in the figures).

The end face 57 of the radial projection 58 also serves as a stop in order to, upon contacting a shoulder 60 of the housing inner wall of the gripping unit housing 44, limit a displacement movement of the lifting piston 16 in the extension direction. The radial projection 58 accordingly defines the extended configuration (end position).

In order to extend the lifting piston 16 from the retracted configuration—counter to the spring loading by the spring device 54—in the extension direction 22, in the housing interior 52, a pressure chamber 62 is formed, by applying compressed air to which a force acting in the extension direction 22 is exerted on the lifting piston 16. In the specific example, the lifting piston 16 delimits the pressure chamber 62 with an end face 64, oriented in the retraction direction 24, of the radial projection 58. In this respect, a positive pressure prevailing in the pressure chamber 62 acts upon the radial projection 58.

The pressure chamber 62 can be supplied with compressed air via the aforementioned compressed air distribution system 26.

To control a compressed air supply to the pressure chamber 62 and therefore a displacement of the lifting piston 16 in the extension direction 22, the gripping apparatus 10 also has a valve device 66, by means of which a flow connection between the compressed air connection and the pressure chamber 62 can be selectively blocked or released. In particular, a separate valve device, in particular a separate compressed air valve, is provided for each gripping unit.

FIG. 2B shows a configuration in which the pressure chamber 62 and therefore the lifting piston 16 is pressurized, so that the lifting piston 16 is transferred from the retracted configuration shown in FIG. 2A into the extended configuration.

The gripping apparatus 10 can also optionally have an integrated control device (not shown) for controlling the valve device (66).

As mentioned above, the lifting piston 16 has an internal negative pressure channel 36 via which the suction gripper 28 can be supplied with negative pressure.

In the example, the negative pressure channel 36 is supplied with negative pressure via a first negative pressure chamber 68 formed in the housing interior 52. The negative pressure chamber 68 is in turn connected to the aforementioned negative pressure distribution system 38 via a chamber opening 70.

As can be seen from FIG. 2A, the chamber opening 70 is sealed in the axially retracted configuration (passive configuration) by a first sealing device 72 arranged on the lifting piston 16, so that a negative pressure supply to the first negative pressure chamber 68 and therefore to the negative pressure channel 36 and thus to the suction gripper 28 is blocked. By displacing the lifting piston 16 in the extension direction 22, the first sealing device 72 is lifted from the chamber opening 70, so that negative pressure can flow via the negative pressure distribution system 38 into the first negative pressure chamber 68 and from there via a radial supply channel 74 into the negative pressure channel 36. In the extended configuration, the suction gripper 28 then assumes an active configuration in which the suction gripper 28 is supplied with negative pressure and can therefore suction an object.

In this respect, by pressurizing the positive pressure chamber 62, on the one hand, an extension of the lifting piston 16 in the extension direction 22 is effected, and, at the same time, a negative pressure supply to the suction gripper 28 is opened. The valve device 66 therefore controls two functions.

The gripping units 14 shown in FIGS. 2A and 2B are optionally designed in such a way that, upon opening the chamber opening 70—as a result of the negative pressure—a force acting in the extension direction 22 is exerted on the lifting piston 16. This self-holding function, which is described in more detail below, is advantageous, but not essential, for the embodiment according to the invention.

As for example can be seen in FIG. 2B, the lifting piston 16 is designed in such a way that the housing interior 52 is divided into the first negative pressure chamber 68, a second negative pressure chamber 76, and the aforementioned (positive) pressure chamber 62, wherein, in the example, the pressure chamber 62 is arranged between the first negative pressure chamber 68 and the second negative pressure chamber 76. The chambers 62, 68, 76 can be changed in size by changing a displacement position of the lifting piston 16 along the lifting axis 20.

In the specific example, the lifting piston 16 separates, using a second sealing device 78, a region of the first housing interior 52, which forms the first negative pressure chamber 68. The aforementioned radial projection 58 in turn separates a section, arranged behind it in the extension direction 22, of the housing interior 52 into the pressure chamber 62 and the second negative pressure chamber 76. To seal the positive pressure chamber 62 from the second negative pressure chamber 76, a third sealing device 80, e.g., in the form of an O-ring, is provided.

The first negative pressure chamber 68 and the second negative pressure chamber 76 are connected to one another in terms of flow via the negative pressure channel 36, so that the second negative pressure chamber 76 can be supplied with negative pressure via the first negative pressure chamber 68. In particular, the same pressure always prevails in the first negative pressure chamber 68 and in the second negative pressure chamber 76. The negative pressure channel 36 can therefore bypass the pressure chamber 62.

If the pressure chamber 62 is at least briefly pressurized with compressed air, the compressed air acts upon the lifting piston 16, in particular the radial projection 58, so that the lifting piston 16 is moved in the extension direction 22 against the spring action of the compression spring 56, and therefore the chamber opening 70 is opened as described above. As a result, negative pressure is fed into the first negative pressure chamber 68 and finally via the negative pressure channel 36 into the second negative pressure chamber 76 (and further into the suction gripper 28).

The negative pressure chambers 68, 76 and the lifting piston 16 are dimensioned in such a way that, due to the negative pressure then present in the negative pressure chambers 68, 76, a force acting in the extension direction 22 is exerted on the lifting piston 16. In the example, this is achieved in that the lifting piston 16 has first surface portions 82 which are oriented in such a way that, due to the negative pressure prevailing in the negative pressure chambers 68, 76 acting upon the first surface portions 82, a force acting in the extension direction 22 is exerted on the lifting piston 16. In the example, such first surface portions 82 are formed for example by the end face 57, oriented in the extension direction 22, of the radial projection 58, which delimits the second negative pressure chamber 76.

In addition, second surface portions 84 are provided which are oriented in such a way that, due to the negative pressure prevailing in the negative pressure chambers 68, 76 acting upon the second surface portions 84, a force acting in the direction of travel 24 is exerted on the lifting piston 16. In the example, such second surface portions 84 are formed for example by the axial end faces of the lifting piston 16, which delimit the first negative pressure chamber 68 (cf. FIG. 2B).

A sum of all first surface portions 82 is greater than a sum of all second surface portions 84, such that a net force acts upon the lifting piston 16 in the extension direction 22. This force is thus superimposed on a force resulting from the application of compressed air.

In order to prevent leakage of negative pressure, in the example, optional additional sealing devices 86 are provided which seal the lifting piston 16 from the housing 20.

In the following, an exemplary embodiment of a method for gripping an object 88 by means of a gripping apparatus 10 described above is explained with reference to FIG. 3, wherein only one gripping unit 14 is considered for simplicity. However, the method can also accordingly be carried out with a plurality of gripping units 14.

In a first step (block 200 in FIG. 3), the gripping apparatus 10 is first provided. Block 200 shows the gripping apparatus 10 in an initial configuration in which the lifting piston 16 is in the retracted configuration—for example, due to the spring loading described above. In this retracted configuration, a negative pressure supply to the suction gripper 28 is preferably initially blocked by the shut-off device 42 (first sealing device 72).

In a further step (block 202 in FIG. 3), compressed air is then applied to the pressure chamber 62 (and therefore the lifting piston 16) at a p_{A} extension pressure, so that it is moved from the retracted configuration in the extension direction 22. As mentioned above, the shut-off device 42 is opened by the extension (the sealing device 72 is lifted from the chamber opening 70) such that negative pressure is now passed via the negative pressure distribution system 38 into the first negative pressure chamber 68, and from there into the negative pressure channel 36 and further to the suction gripper 28.

The extension pressure is preferably selected in such a way that the lifting piston 16 is transferred into the extended configuration (counter to the spring load). For example, the pressure chamber 62 can be pressurized with compressed air at 5 bar.

The gripping apparatus 10 with the gripper 18 is then placed on the object 88 to be gripped (block 204 in FIG. 3).

Before placement, but at the latest at the moment of placement, the pressure of the compressed air is reduced from the extension pressure p_{A} to a preset pressure p_{H}—for example, from 5 bar to 0-2 bar.

As described above, this allows the lifting piston 16 to yield to a certain extent in the retraction direction 24 upon placement (“compression” of the lifting piston 16) and therefore, on the one hand, damage to the object 88 or the gripping apparatus 10 can be prevented and, on the other, reliable gripping (in particular, reliable sealing of the suction gripper 28) is enabled, since possible unevennesses on the surface of the object 88 can be compensated for by the lifting movement.

As shown in block 204, the gripping apparatus 10 is preferably actively positioned in such a way that the lifting piston is pushed at least partially into the gripping unit housing 44 in the retraction direction 24.

If the object 88 is gripped, e.g., suctioned by the suction gripper 28, then, in a further step (block 206 in FIG. 3), the pressure of the compressed air and therefore a pressure acting upon the lifting piston 16 is increased to a main pressure p_{H} in such a way that the lifting piston 16 is transferred into the extended configuration (end position) and therefore fixed. The main pressure p_{H} can in particular correspond to the extension pressure p_{A}—for example, 5 bar.

As mentioned above, it is also conceivable that, before the pressure chamber 62 or the lifting piston 16 is pressurized with the main pressure p_{H}, the gripping apparatus 10 and therefore the object 28 be lifted, so that the lifting piston 16 is already transferred into the extended configuration by the weight of the object 88 against the spring load.

1. A method for handling an object by a gripping apparatus or a suction gripping apparatus, including a gripper base body and at least one gripping unit, held on the gripper base body, including a lifting piston and a gripper or a suction gripper, which is coupled by movement to the lifting piston, for gripping the object, wherein the lifting piston is adjustable relative to the gripper base body along a lifting axis between an axially retracted configuration and an axially extended configuration in an extension direction and in a retraction direction opposite the extension direction, wherein the lifting piston is extendable in the extension direction by applying compressed air, the method comprising:
applying an extension pressure to the lifting piston so that the lifting piston is extended in the extension direction starting from the retracted configuration;
placing the gripper coupled in motion with the extended lifting piston onto the object to be gripped;
gripping the object with the gripper, or suctioning the object with the suction gripper, wherein
the lifting piston is subjected to a preset pressure when placing the gripper and is subjected to a main pressure after placement, or after gripping, wherein the preset pressure is lower than the main pressure.

2. The method according to claim 1, wherein the main pressure is selected in such a way that the lifting piston is transferred into the extended configuration and/or held in the extended configuration by the application of the main pressure.

3. The method according to claim 1, wherein the preset pressure is at most half as high as the main pressure.

4. The method according to claim 1, wherein the preset pressure corresponds to the ambient pressure.

5. The method according to claim 1, wherein the preset pressure is between 0 and 2 bar and/or wherein the main pressure is between 4 and 6 bar or between 4.5 and 5.5 bar.

6. The method according to claim 1, wherein the lifting piston is spring-loaded into the retraction direction, wherein the preset pressure is selected in such a way that the lifting piston is transferred into the extended configuration or into an intermediate position between the retracted configuration and the extended configuration when freely extended—counter to the spring load.

7. The method according to claim 1, wherein the extension pressure is greater than the preset pressure, or corresponds to the main pressure.

8. The method according to claim 1, wherein the placement is carried out in such a way that the lifting piston is displaced in the retraction direction during placement—counter to the application of the preset pressure.

9. The method according to claim 1, wherein a sensor device is provided for monitoring a gripping state of the gripper, wherein a gripping state of the gripper is monitored by means of the sensor device, and the pressure acting upon the lifting piston is changed as a function of an output signal of the sensor device, wherein the pressure acting upon the lifting piston is increased from the preset pressure to the main pressure upon detection of the gripping of an object by the gripper.

10. The method according to claim 1, wherein the gripper is designed as a suction gripper which delimits a suction chamber open through a suction opening, wherein a sensor device is provided for monitoring a negative pressure prevailing in the suction chamber, wherein, during the placement, the negative pressure prevailing in the suction chamber is monitored by the sensor device, wherein, when a pressure threshold value is exceeded or undershot, the pressure acting upon the lifting piston is increased from the preset pressure to the main pressure.

11. A handling apparatus for carrying out said method according to claim 1, the handling apparatus comprising:
a gripping apparatus including a gripper base body and at least one gripping unit, held on the gripper base body, comprising a lifting piston and a gripper coupled in motion to the lifting piston for gripping the object, wherein the lifting piston is adjustable along a lifting axis between an axially retracted configuration and an axially extended configuration in an extension direction and in a retraction direction opposite the extension direction relative to the gripper base body, wherein the gripping unit comprises a gripping unit housing in which the lifting piston is displaceable, wherein, in the gripping unit housing, a pressure chamber is formed, which fluidically interacts with the lifting piston in such a way that, by applying compressed air to the pressure chamber, a force acting in the extension direction is exerted on the lifting piston;
a compressed air supply device for supplying the pressure chamber with compressed air;
a pressure adjustment device for adjusting a supply pressure of the compressed air;
optionally, a manipulator for displacing the gripping apparatus; and
a control device for controlling the handling apparatus, wherein the control device is configured to carry out the method according to claim 1.

12. The handling apparatus according to claim 11, wherein the gripper is designed as a suction gripper, wherein the suction gripper can be supplied with negative pressure through the lifting piston connected thereto.

13. The handling apparatus according to claim 11, wherein the suction gripper delimits a suction chamber open through a suction opening, wherein a sensor device cooperating with the control device is provided for monitoring a negative pressure prevailing in the suction chamber, wherein the control device is configured to control the sensor device in such a way that the sensor device monitors the negative pressure prevailing in the suction chamber during the placement of the suction gripper on the object to be gripped, wherein the control device is also configured to control the pressure setting device in such a way that the pressure setting device increases the pressure acting upon the pressure chamber from the preset pressure to the main pressure when a pressure threshold value in the suction chamber is exceeded or undershot.

14. The handling apparatus according to claim 12, wherein the gripping apparatus has a negative pressure connection for connection to a negative pressure supply device, wherein the gripping unit is designed in such a way that, in the extended configuration of the lifting piston, a flow connection is established between the negative pressure connection and the suction gripper, and, in the retracted configuration of the lifting piston, this flow connection is blocked.
